(19) United States
(12) Patent Application Publication
(10) Pub. No.: US 2002/0177912 A1
(43) Pub. Date: Nov. 28, 2002

(54) Endless operation without reset of a multi-stage control device with stages of finite range

(76) Inventor: Donald J. Sobiski, Horseheads, NY (US)

Correspondence Address: William S. Francos, Esq., VOLENTINE FRANCOS, PLLC, 50 Commerce Drive, Wyomissing, PA, 19610, US

(21) Appl. No.: 10/151,448

(22) Filed: May 20, 2002

Related U.S. Application Data
(60) Provisional application No. 60/292,410, filed on May 21, 2001.

(51) Int. Cl. G05B 15/02

(52) U.S. Cl. 700/33; 700/9; 700/50

(57) ABSTRACT

A method of controlling a plurality of stages, each having a finite range of operation, is disclosed. The method comprises determining a state of operation of a selected one of operation is approaching a threshold; and, thereafter, selectively altering a state of operation of the other devices so that a desired output is continuously maintained for each input.

A control architecture includes a controller, which determines a state of operation of a selected one of a plurality of stages is disclosed. The controller alters the state of operation of the selected one of the plurality of stages if the state of operation is approaching a threshold. The controller selectively alters the state of operation of the other devices so that a desired output is maintained for each input.

### CROSS-REFERENCE TO RELATED APPLICATIONS

The present application claims priority under 35 USC § 119(e) from U.S. provisional application 60/292,410 filed May 21, 2001, and entitled “Endless Operation Without Reset of Multi-Stage Device With Stages of Finite Range.” The disclosure of this provisional application is specifically incorporated by reference herein and for all purposes.

### FIELD OF THE INVENTION

The present application relates generally to control systems, and particularly to a control method and apparatus that provides operation without reset of a multistage control device with stages of finite range.

### BACKGROUND

In a wide variety of technologies, it is often useful to control certain variables in multiple control stages, with each stage exerting some degree of control over the range of the variables. In achieving this end, many types of devices may be controlled by a feedback loop control architecture. Moreover, many of these deployed devices are composed of stages that have a finite range of operation, and, therefore, influence over variable(s).

Because each stage has a finite range of operation, it is possible that stage(s) may reach the limit of its range of influence during the control of one or more variables. The range of influence is limited to both a maximum and a minimum, which represents the largest and smallest amounts of influence achievable. This is known as saturation. When one or more stages reaches the limit of its range of operation, the control device is no longer effective, and the effectiveness of the control architecture in which the stages function is diminished, if not nullified.

Once a stage reaches saturation, it may be reset within its range of operation, allowing it to resume its influence over a variable(s). However, resetting can create transients in the system caused by a loss of control during this period of reset. These transients are undesirable in certain applications. Moreover, known techniques to avoid reset and its attendant problems have drawbacks. For example, systems incorporating known reset methods can be difficult to maintain, can age poorly during operation, and may require additional instrumentation. Furthermore, known techniques to avoid reset can require computationally intensive algorithms, which add to the complexity of the technique and which can add unacceptable delays to processing throughput.

What is needed, therefore, is a method and apparatus for controlling a multistage compensation device, which overcomes the drawbacks and shortcomings of the known techniques described above.

### SUMMARY OF THE INVENTION

In accordance with an exemplary embodiment of the present invention, a method of controlling a plurality of stages, each having a finite range of operation, is disclosed. The method comprises determining a state of operation of a selected one of the plurality of devices; altering the state of operation of the selected device if the state of operation is approaching a threshold; and, thereafter, selectively altering a state of operation of the other devices so that a desired output is continuously maintained for each input.

In accordance with another exemplary embodiment of the present invention, a control architecture includes a controller, which determines a state of operation of a selected one of a plurality of stages. The controller alters the state of operation of the selected one of the plurality of stages if the state of operation is approaching a threshold. The controller selectively alters the state of operation of the other devices so that a desired output is maintained for each input.

### DESCRIPTION OF THE DRAWINGS

The invention is best understood from the following detailed description when read with the accompanying drawing figures. It is emphasized that the various features are not necessarily drawn to scale. In fact, the dimensions may be arbitrarily increased or decreased for clarity of discussion.

FIG. 1 is a functional block diagram of a control architecture in accordance with an exemplary embodiment of the present invention.

FIG. 2 is a Poincaré sphere showing the how a two stage of polarization transformation device can affect an input state of polarization.

FIG. 3(a) is a Poincaré sphere showing the transformation of an input state of polarization to an output state of polarization through the actions of a four-stage polarization transformation device in accordance with an exemplary embodiment of the present invention.

FIG. 3(b) is a view of the Poincaré sphere of FIG. 3(a) shown from the vantage point of the arrow shown in FIG. 3(a), and including an alternate input/output path showing endless operation with reset (EOR) in accordance with an exemplary embodiment of the present invention.

FIG. 4 is a flow chart of an EOR method in accordance with an exemplary embodiment of the present invention.

FIG. 5 is a graphical representation of a membership function in fuzzy logic in accordance with an exemplary embodiment of the present invention.

FIG. 6 is an set of decision rules in accordance with an exemplary embodiment of the present invention.

### DETAILED DESCRIPTION

In the following detailed description, for purposes of explanation and not limitation, exemplary embodiments disclosing specific details are set forth in order to provide a thorough understanding of the present invention. However, it will be apparent to one having ordinary skill in the art having had the benefit of the present disclosure, that the present invention may be practiced in other embodiments that depart from the specific details disclosed herein. Moreover, descriptions of well-known devices, methods and materials may be omitted so as to not obscure the description of the present invention.

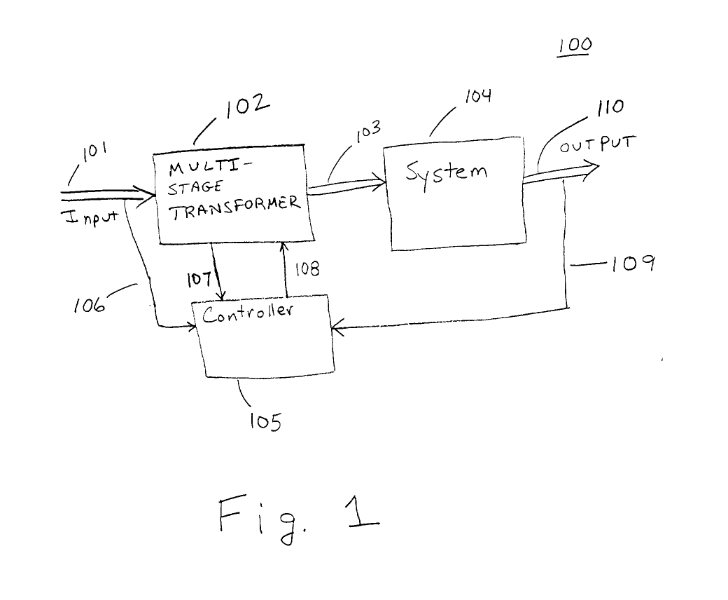

FIG. 1 shows a controller architecture 100 deployed in a system 104 to be controlled during its operation. An input 101 is input to a multi-stage transformer (MST) 102, which selectively performs an operation on the input 101. The output 103 from the MST 103 is input to a system 104, having desired characteristics by virtue of the MST 102.

A controller 105 receives an input sampling 106 of the input 101, an output sampling 107 of the output 103 of the MST 102 and an output sampling 109 from an output 110 of the system 104. Based on the input sampling 106 and output samplings 107 and 109, adjustment commands 108 can be made by the controller to one or more stages of the MST 102 to effect any necessary changes to the input 101 so that the output 103 of the MST 102 has certain desired characteristics upon being input to the system 104. Ultimately, the output 103 of the MST 102 ensures the output 110 of the system 104 is at a certain level of operation within a prescribed tolerance.

It is noted that the input 101 may be from a system (not shown) of which system 104 is a part. To this end, the MST 102 may be disposed in-line with this system, effecting changes to the input 101 before it is sent to the system 104. Alternatively, the input 101 may be from another source and may require the actions of the MST 102 before being input to the system. It is further noted that a plurality of controller architectures 100 may be strategically located across the system so that adjustments may be selectively carried out. To this end, the output 110 could be the input (e.g. input 101) of another controller architecture (not shown) that is identical to controller architecture 101. Further cascading could be carried out to achieve desired results. Still other variants are possible.

As will become clearer as the present description proceeds, the controller 105 also effects the required adjustment commands 108 of the stages of the MST 102 using the sampling 107 in a manner that prevents any one stage from reaching saturation, thereby preventing the loss of control of the stage. Moreover, this is accomplished in concert with the maintenance of the desired parameters of the output 110. This often requires the maintenance of a relationship between the input 101 and the output 103 of the MST and the output 110 of the system 014.

The adjustment commands 108 from the controller changes the settings of the individual stages of the multi-stage transformer 102 based on calculations and criteria described in detail below. Briefly, the altering of the level of operation of one of the plurality of stages, if required, is followed in sequence by the altering of the output of the other stages (again, if required) to ensure the desired output 110 is maintained, and that none of the stages reaches a maximum or minimum threshold. In many applications of the architecture and method of use, it is useful to have redundancy in the capabilities of the individual stages to ensure that the maintenance of the desired output 110 is met and is done so without any stage reaching a maximum or minimum level of operation.

It is noted that the description that follows focuses primarily on the use of the controller architecture 100 and it method of use in a multi-stage polarization transformation device for use in optical systems. As such, input 108 is illustratively an optical signal of an optical communications system, and the MST 102 is an in-line device of the communications system. For example, the optical communication system may be a long haul system that requires periodic polarization mode dispersion (PMD) compensation. The MST 102 could be strategically located to perform this needed task. Moreover, a plurality of controller architectures 100 could be strategically positioned along the long-haul system to effect the PMD compensation along the system. A more detailed discussion of polarization mode dispersion and the need to compensate therefor, may be found in U.S. patent application Ser. No. 09/945,163, entitled “Fiber Squeezing Device,” and filed on Aug. 31, 2001. The disclosure of this application is specifically incorporated herein by reference and for all purposes.

However, it is emphasized that the controller architecture and its method of use according to the present invention may be used to effect control of multi-stage control devices for many diverse systems. It is common to all such systems that a particular system output is desired; that the input to the system may vary; that the individual stages of the multi-stage control device are necessarily prevented from reaching saturation, and without having to be reset; and that the desired output is realized to within an acceptable tolerance regardless of the variance in the input.

Exemplary uses of the control architecture and method include, but are not limited to systems for: maintaining a constant output flow from a network of interconnected pipes with valves; and delivering a constant amount of electric power to specific points with a power grid through the use of electric controls.

As mentioned, the controller architecture 100 and method of use may be used to compensate for polarization mode dispersion in an optical system. The polarization transformers (not shown) that comprise the multi-stage transformer 102 in the exemplary application are illustratively of the type described in detail in the above-referenced application entitled “Fiber Squeezing Device.” Alternatively, they may be nematic crystal-based polarization transformers, PLZT crystal-based polarization transformers, as well as other types of transformers for altering the birefringence of an optical waveguide to affect the state of polarization as may be required for PMD compensation, or other application.

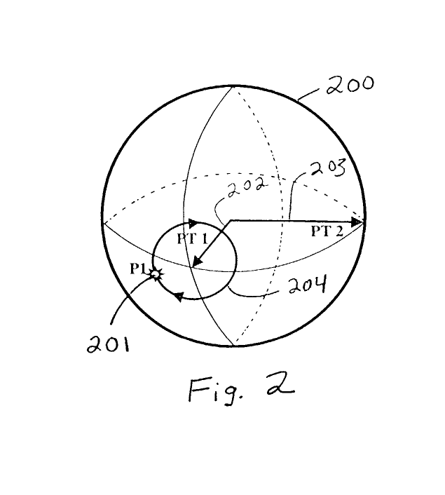

FIG. 2 depicts how one polarization transformer oriented along the ordinary axis of the waveguide and another along the extraordinary axis affect the input state of polarization. The Poincaré sphere 200 is a known graphical tool that allows the convenient description of the state of polarization and the polarization transformation caused by the polarization transformers. As is known, any state of polarization can be uniquely represented by a point on or in the sphere. Fully polarized light is represented by a point on the sphere.

In the example of FIG. 2, an input state of polarization (P1) 201 may be transformed by a first polarization transformer (PT1) oriented along a first axis 202 and a second polarization transformer (PT2) oriented along a second axis 203. PT1 can cause the input state of polarization 201 to move through a phase change described by a circle 204 centered about the first axis 202, and having a radius that is the distance from the point where the axis intersects the sphere to the location of P1. Moving the polarization state through a complete revolution of the circle 204 correspond to a phase change of 2π radians. Similarly, PT2 can cause the input polarization state P1 201 to rotate through a circle (not shown) centered on second axis 203, and having a radius defined by the distance from the point of intersection of the second axis 203 and the location of P1 201.

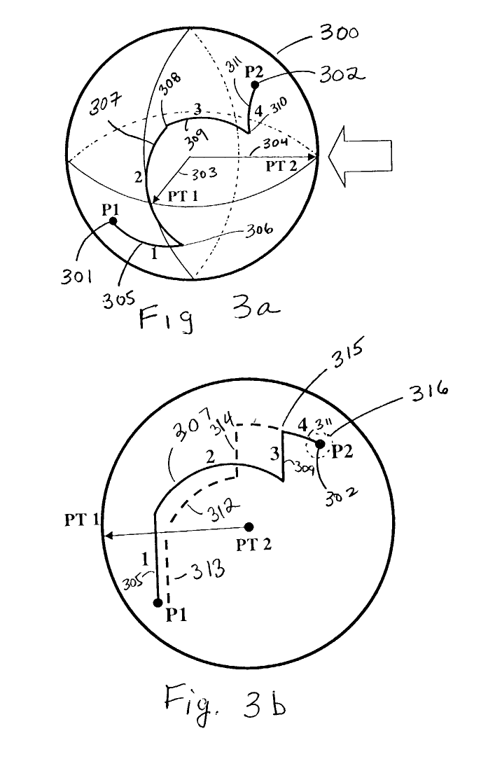

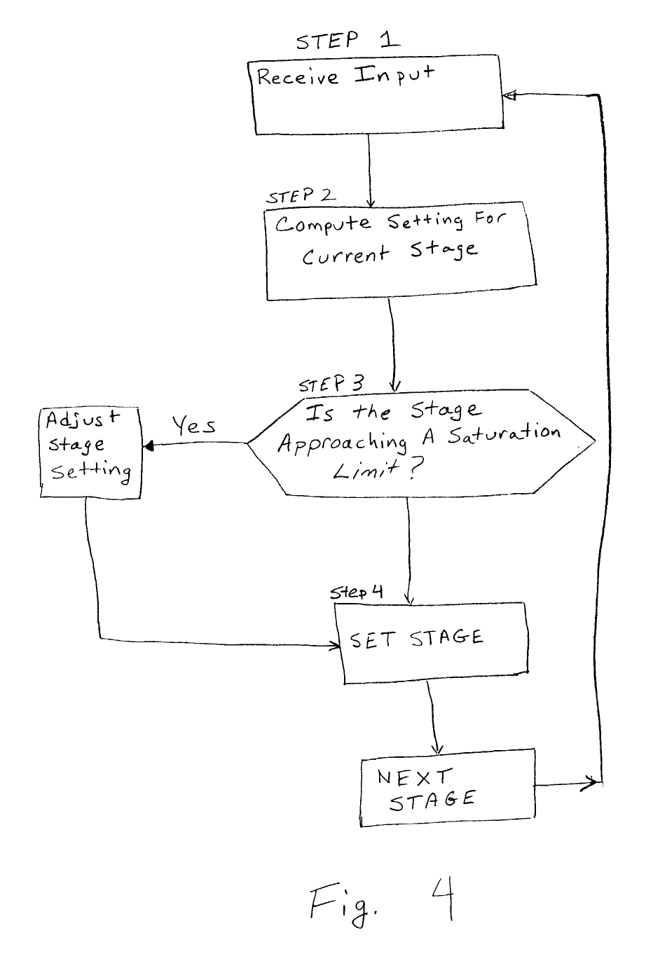

FIGS. 3(a) and 3(b) depict the transformation of an input state of polarization to an output state of polarization using a four PT's in accordance with an exemplary embodiment of the present invention. The description of 3(b) is best understood if reviewed in conjunction with the flow chart of FIG. 4, which depicts an exemplary method of effecting endless operation without reset in accordance with an exemplary embodiment of the present invention.

Turning first to FIG. 3(a), an input polarization state (PI) 301 is transformed into a desired output state of polarization (P2) 302 through the actions of four PT's. The first and third PT's are oriented parallel a first axis (PT1) 303 of the Poincaré sphere 300 and the second and fourth Pt's are oriented along a second axis (PT2) 304 of the Poincaré sphere. Of course, this may represent the action of two PT's oriented along the ordinary axis of a birefringent waveguide, and two PT's oriented along the extraordinary axis, such as is described in the above captioned application.

As will become more clear as the present description proceeds, use of pairs of PT's along each of the first and second axes acting in concert enables a change in the actuation of one of the PT's if it is operating at or near a preset threshold and the subsequent change in the actuation of the other of the pair to effect the needed induced birefringence along the particular axis to maintain the output state of polarization at a desired level within acceptable tolerance. In accordance with an exemplary embodiment of the present invention, this redundancy along each axis ultimately enables the endless transformation of any input state of polarization 301 to a desired output state of polarization without having to reset any of the PT's during operation.

The first stage of the transformation is the action of the first PT resulting in the rotation from P1 301 along a first section 305 of the sphere 300. The second PT then rotates the state of polarization from the endpoint 306 of first section 305 through a second section 307 of sphere 300. Similarly, from the endpoint 308 of second section 307 the third PT rotates the state of polarization through a third section 309, to an endpoint 310; and fourth PT rotates the state of polarization through a fourth section 311 to the desired output polarization state 302.

It is apparent that in the illustrative phase transformation the rotation through second section 307 is the largest, which means the second PT created the greatest change in the phase of the state of polarization. Because this phase change is greatest, the second PT is using the greatest amount of its finite range of change in the birefringence. Moreover, if the input polarization 301 were to move, and the desired output polarization remains fixed, it is foreseeable that increased phase changes would be required of the PT's.

The exemplary embodiment of the present invention ensures that none of the PT's reach a minimum nor a maximum level of actuation regardless of any change in the input polarization state (e.g., P1 301) and/or desired output state (e.g., P2 302), or for other reasons. To this end, because both the minimum and maximum levels of actuation represent points in the range of actuation beyond which no further control is possible, both levels are a referred to as a saturation limit. In the maximum case, no additional change can occur because no more energy can be applied to the stage to affect a change, and in the minimum case, no more energy can be removed from the stage to effect a change.

FIG. 3(b) includes an alternative polarization transformation (from the input polarization state 301 to the desired output polarization state 302) along with the transformation shown in FIG. 3(a) from the vantage point of the ‘arrow’ of FIG. 3(a). In FIG. 3(b) the circles of PT1 are viewed from the side, and thus appear as straight lines, while the circles of PT2 are viewed straight-on.

Step 1 of FIG. 4 is the initial reading in which the input polarization state is received by known techniques. Next at Step 2, the four PT's are set to transform the input polarization state to the desired output polarization, for example the transformation of FIG. 3(a) (shown in solid line in FIG. 3(b)).

Step 3 of the illustrative method of FIG. 4 a command from the controller (e.g., controller 105) begins an adjustment to the input to a selected one of the PT's, if required, if the selected PT is approaching a minimum or maximum threshold. Illustratively, the adjustment process begins when the stage is in the last 25% of its actuation range, although other criteria may be used. The amount of adjustment is a function of the proximity to a minimum or maximum threshold (saturation). To wit, the closer that the end of the range is approached, the greater the adjustment that is applied. This adjustment is continuous and gradual, to keep the system operating at its nominal set point (e.g. desired output polarization state 302), and to avoid introducing undesirable transients. To this end, the operational state is monitored by the controller (e.g., controller 105), and is altered as required according to the presently described method. For example, as mentioned, the second section 307 adds the greatest phase change to the optical signal. It is conceivable that this would cause the second PT to approach saturation.

In accordance with the controller architecture and method of the presently described exemplary embodiment, Step 3 of FIG. 4 would reduce the phase shift gradually if it were causing the second PT to approach its maximum threshold (saturation), while monitoring the system state and adjusting the level of all the other PT's accordingly to maintain the desired output level. Similarly, if the PT were approaching its minimum threshold, a suitable adjustment would be effected.

Next, after the operating level of the second PT has been altered per Step 3, in Step 4, if necessary, the operational levels of any of the remaining PT's would be altered to ensure the desired output polarization state P2 302 is maintained. The sequence of Steps 1 to 4 could then be repeated, with any changes in the input polarization state being accounted for in the process. To this end, if a necessary adjustment in the operational level of a PT is made to avoid a threshold, the exemplary method adjusts the other PT's to account for the change that has been commanded. This entire process is repeated on each PT continuously and, if needed, further adjustments to the PT's are carried out in like manner. Of course, if a change is not needed in any application of the process sequence of FIG. 4, no action is taken.

The results of the control architecture and method of the presently described exemplary embodiment are shown in the dotted line transformation of FIG. 3(b). By Step 3, the operational level of the second PT is reduced, which is manifest in the reduction of the phase change of the optical signal of a second section 312 compared to the second section 307 of the previous transformation. This mandates the adjustment of the other three PT's. Illustratively, the operational level of the first PT is reduced, which is manifest in the reduction in the phase change of the optical signal in a first section 313 compared to the first section 305. Likewise, to achieve the desired output polarization state 302, the operational level of the third PT is slightly increased, which is manifest in a slight increase in the phase change in a third section 314 compared to the third section 309. Finally, the level of operation of the fourth PT is increased, which is manifest in an increase in the phase change of a fourth section 315 (which completes the transformation to the desires output state 302) when compared to the fourth section 311. It is noted that the process of adjusting the PT's is done incrementally, and serially to always keep the system within an acceptable range of its nominal set point (e.g. the desired output polarization state P2 302) for desired performance, and to allow for the processing of any changes that may occur in the input state (e.g. a variation in the input state of polarization P1 301) due to system dynamics or other disturbance.

A few noteworthy points of the illustrative embodiment of FIG. 3(b) and 4 are discussed presently. For example, it is noted that the input polarization state can vary, and that it may be useful to have the desired output polarization state at a different point than that shown in FIG. 3(b). By virtue of the illustrative method of the exemplary embodiment of the present invention both of these scenarios are accommodated while maintaining endless operation without reset and the desired level output polarization state.

For example, if the input polarization changes, the method may adjust the operational level of the first PT and then the others in sequence to ensure that the transformation to the desired output polarization state is reached. Moreover, through the continuous iterations of the method shown in FIG. 4, the accommodation for a change in the input polarization state is realized without reaching the minimum and maximum threshold of any of the individual PT's.

Likewise, if the output polarization state is desirably changed, the operational level of the fourth PT may be adjusted to meet the desired output polarization. Again this is accomplished iteratively and the minimum and maximum thresholds of the PT's are avoided.

The ability to accommodate for the changes in the input polarization, or the output polarization, or both while meeting the desired output polarization without reaching a minimum or maximum threshold of a PT and in an endless (continuous) manner, is a result of the use of the closed loop control in combination with the duplication of the correction for each degree of freedom (for example, in this exemplary embodiment of the present invention, there are pairs of PT's aligned with each of the orthogonal polarization states/ orthogonal ordinary and extraordinary axes). This duplication enables the system to rely on the one PT adjustment along the particular degree of freedom if the other PT is nearing a threshold. Moreover, the closed loop control method enables the adjustments to the PT's to be made sequentially with the known state of operation of the other PT's.

Advantageously, the sequential monitoring and adjustment (if needed) of a PT in accordance with an exemplary embodiment of the present invention, results in a relatively computationally simple method of operation. To this point, if one were to have to compute the required operational levels of each of the PT's simultaneously (effectively ‘precomputing’ the required levels for a given transformation) the calculations would be complex, and slow when compared to those of the presently described exemplary embodiment. Such a precomputation could result in an unacceptable delay in adjusting the PT's. Ultimately, this could result in an unacceptable amount of error in maintaining the system set point. Moreover, such a system would require continuous calibration of the PT's, which can further add to the delay or error or both.

In contrast, the method of the present exemplary embodiment is sequential, with the operational level of one of the PT's being adjusted if needed to avoid a threshold, and thereafter the remaining PT's being adjusted to meet the desired transformation. This results in the capability of effecting the adjustment of all devices in a period that is constrained by the hardware limitations such as A/D settling time. The total period is typically approximately 3 milliseconds. Accordingly, the output polarization state will always be at a desired point within an acceptable tolerance, which is shown as a circle 316 in FIG. 3(b). This tolerance is dictated by the desired performance for the system—in an optical communications system, this range is typically ±10 degrees, within which the Bit Error Rate remains at an acceptable level.

Finally, it is noted that by virtue of the method and controller architecture of the exemplary embodiment, none of the PT's individually or in combination could reach a threshold. For example, if a drastic change occurred in the input polarization state, it could require significant phase changes to effect the transformation to reach the desired output polarization state. However, because the controller architecture of the present invention adjusts the operational level of one PT at a time (i.e. sequentially), in this scenario the operational level of this one may be increased, with the others adjusted in sequence per the method of FIG. 4. Of course the present method would keep the system operating within a tolerance of its nominal operating point (e.g. within circle 316), and not allow any PT to reach saturation, provided that the rate of change of input is within the bandwidth of response of the controller. If the rate of change is greater than the controller bandwidth, the PT's would still be kept from saturation, but system performance would degrade. Moreover, the iterative method would sequentially alter the operational level of any PT that was operating near a threshold to ensure that threshold is avoided, and the desired output polarization state is maintained with the prescribed tolerance.

The controller architecture and method of the exemplary embodiments described thus far may be implemented as a continuous set logic controller that acts to perturb a feedback control system in such a manner as to cause Steps 3 and 4 of FIG. 4 to be executed as described, although other implementations are possible. A continuous set logic controller is also known as a fuzzy logic controller.

As is known, fuzzy logic is useful in determining solutions that are not easily described mathematically. The mathematical calculation required to move the four PT's from one step to the other in the polarization transformation is exceedingly complex. As such the determination of the required alteration of each of the PT's lends itself well to fuzzy logic.

The controller architecture 100 includes the multi-stage transformer 104 with the four PT's discussed herein. The PT's are in pairs as described, and each pair has a voltage associated therewith that is the input command from the controller 105 to that PT (e.g. V1 and V3 for the pair of PT's that are aligned with first axis 303, and V2 and V4 for the pair of PT's that are aligned with second axis 304). Changing the voltage to any one of the PT's changes the phase angle rotation of that PT, which alters the path of the sections shown in FIGS. 3(a) and 3(b).

A membership function is designed for each voltage range that encompasses all possible voltage inputs to a PT. An example of such a membership function is shown in FIG. 5. In this example, −1 corresponds to the minimum allowable voltage input, and +1 correspond to the maximum allowable voltage input. Any input outside these bounds will have no effect, since a voltage outside this range would result in operation outside the minimum or maximum threshold.

The membership classes appear as triangles NL, NS, ZE, PS and PL, for negative small, negative large, zero, positive small and positive large, respectively. The degree of membership, or membership weight, of an input is determined as being the area of each triangle that the input occupies. For example, if VI is the input voltage of 0.25, it will have a membership weight of 0.75 in the class ZE, and a membership of 0.25 in the class PS. Likewise, if V3 is the input voltage of −0.8, it will have a membership of 0.2 in the class NL, and a membership weight of 0.8 in the class of NS.

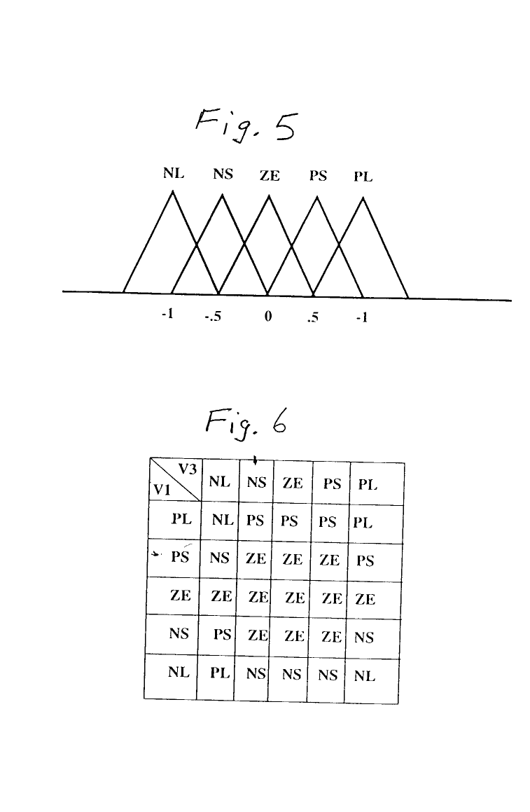

Next, a set of decision rules is defined. The decision rules define the control action that will be taken for a given set of memberships V1 and V3 in the present example. An example of a set of decision rules is given in FIG. 6. If V1 is PS and V2 is NL, the set of decision rules of FIG. 7 indicates that the decision rule should be NS. The possible decisions are obtained by taking all possible combinations of the membership classes of V1 and V3 (i.e., (ZE,NL), (ZE,NS), (PS,NL) and (PS,NS)), and then applying them to the decision rules, which results in (ZE,ZE,NS,ZE).

Next the weight of each decision is found by using a fuzzy intersection operator on the membership weights, which is:

Wₖ=∩(wᵢ,wⱼ)=min(wᵢ,wᵢ)i,j =1,2k=i+j (1)

where wᵢ, wⱼ are the membership weights of each input in their respective membership classes.

Finally, a control action is determined by computing the center of ‘gravity’ of all of the weighted decision rules:

$${C}_{action} = {\sum }_{k = 1}^{4} {W}_{k} {D}_{k} / {\sum }_{k = 1}^{4} {W}_{k} \qquad ( 2 )$$

where Dₖ is the decision rule corresponding to the weight Wₖ.

The control action, C_{action}, is then injected into the control loop of the controller architecture by the controller 105, and the control law is modified by this control action as well. The input for that stage is then modified to avoid its threshold, an the controller issues commands to the other PT's of the MST 102 to account for any change that has been commanded, in a manner described in connection with the exemplary method of FIG. 4.

As can be appreciated from the above detailed description, the present invention is particularly useful in addressing the problem of endless operation without reset when stages of finite range are used in feedback control devices. Beneficially, the control architecture and method do not require calibration of the stages (e.g., the PT's) of the MST; do not require information regarding the internal state of the stages of the MST; self-correct through feedback; are relatively simple to implement in software; and are relatively fast and accurate in operation. Moreover, the control architecture and method are versatile, being readily adapted to a variety of systems requiring of endless operation without reset when finite range stages are used in feedback control devices.

The invention having been described in detail in connection through a discussion of exemplary embodiments, it is clear that modifications of the invention will be apparent to one having ordinary skill in the art having had the benefit of the present disclosure. Such modifications and variations are included in the scope of the appended claims.

1. A method of controlling a plurality of devices each having a finite range of operation, the method comprising:
determining a state of operation of a selected one of the plurality of devices; altering the state of operation of the selected device if the state of operation is approaching a threshold; and, thereafter, selectively altering a state of operation of the other devices so that a desired output is maintained for an input.

2. A method as recited in claim 1, wherein said desired output is within a prescribed tolerance.

3. A method as recited in claim 1, wherein said input is variable.

4. A method as recited in claim 1, wherein each of said plurality of devices is a polarization transformation device.

5. A method as recited in claim 1, wherein there are n (n=integer) degrees of freedom, and said plurality of devices equals 2n.

6. A method as recited in claim 4, wherein said input is an input state of polarization, and said output is an output state of polarization.

7. A method as recited in claim 4, wherein a pair of said polarization transformers is aligned with an ordinary axis of birefringence of a waveguide, and another pair of said polarization transformers are aligned with an extraordinary axis of said waveguide.

8. A method as recited in claim 1, wherein said devices are controlled not to reach a maximum threshold.

9. A method as recited in claim 1, wherein said devices are controlled not to operate below a reach threshold.

10. A method as recited in claim 9, wherein said determining of state of operation further comprises applying fuzzy logic.

11. A control architecture, comprising:
a controller, which determines a state of operation of a selected one of a plurality of devices, and which alters the state of operation of the selected one of the plurality of devices if the state of operation is approaching a threshold, wherein said controller sequentially and selectively alters a state of operation of the other devices so that a desired output is maintained for an input.

12. A control architecture as recited in claim 11, wherein said desired output is within a prescribed tolerance.

13. A control architecture as recited in claim 11, wherein said input is variable.

14. A control architecture as recited in claim 11, wherein each of said plurality of devices is a polarization transformation device.

15. A control architecture as recited in claim 11, wherein there are n (n=integer) degrees of freedom, and said plurality of devices equals 2n.

16. A control architecture as recited in claim 14, wherein said input is an input state of polarization, and said output is an output state of polarization.

17. A control architecture as recited in claim 14, wherein a pair of said polarization transformers is aligned with an ordinary axis of birefringence of a waveguide, and another pair of said polarization transformers are aligned with an extraordinary axis of said waveguide.

18. A control architecture as recited in claim 11, wherein said devices are controlled not to exceed a maximum threshold.

19. A control architecture as recited in claim 11, wherein said devices are controlled not to operate below a minimum threshold.

20. A control architecture as recited in claim 18, wherein said controller determines said states of operations using fuzzy logic.
